(19) United States
(12) Patent Application Publication
(10) Pub. No.: US 2006/0031506 A1
(43) Pub. Date: Feb. 9, 2006

(54) System and method for evaluating policies for network load balancing

(75) Inventor: Karl N. Redgate, Pepperell, MA (US)

Correspondence Address: LAHIVE & COCKFIELD, LLP., 28 STATE STREET, BOSTON, MA, 02109, US

(73) Assignee: SUN MICROSYSTEMS, INC., Santa Clara, CA (US)

(21) Appl. No.: 10/837,366

(22) Filed: Apr. 30, 2004

(51) Int. Cl. G06F 15/173

(52) U.S. Cl. 709/226

(57) ABSTRACT

Methods and systems for evaluating policies for load balancing in a network environment are disclosed. A switch provides load balancing of requests among different servers using an expression tree comprising data structures of precompiled executable code to determine an appropriate server group for sending traffic. When the switch receives a network request, such as an HTTP request, a policy evaluation processor executes the precompiled executable code to identify a group of network servers for servicing the request and forwards the request to the selected group of network servers. The request can be load balanced among the selected server group through any suitable load-balancing algorithm.

### FIELD OF THE INVENTION

The present invention relates generally to network environments and more particularly to methods and systems for distributing traffic among network servers.

### BACKGROUND OF THE INVENTION

In network communications systems, switches may employ load balancers to distribute traffic efficiently among network servers, so that no individual server is overburdened. A load balancer is a device for allocating requests from the clients to the plurality of servers in a network by applying a suitable algorithm. The use of the load balancer prevents the client requests from concentrating on and overloading a single server.

Network load balancing distributes IP (Internet Protocol) traffic to multiple copies (or instances) of a TCP/IP service, such as a Web server, each running on a host within the cluster. Network load balancing transparently partitions the client requests among the hosts and allows the clients to access the cluster using one or more “virtual” IP addresses. From the client perspective, the cluster appears to be a single server that answers all client requests. As enterprise traffic increases, network administrators can simply plug another server into the cluster to accommodate the increased traffic, without causing disruptions to service.

To perform load balancing, a switch inspects every incoming HTTP (Hyper Text Transfer Protocol) request, and makes further request forwarding decisions using several advanced dynamic algorithms. These algorithms seek to optimize the use of the back-end servers to effectively distribute the content of the web sites across all the servers in parallel, as well as to preserve HTTP sessions between a client and the back-end server. This brings efficiency in content delivery, giving visitors better performance and IT managers better utilization of their hardware.

A switch employing a load balancer groups each network server into a server group based on user-specified criteria. The switch then selects a server group to service each incoming network request based on user-specified policies stored in a policy program. The user-specified policies are generally represented as programming language expressions that are evaluated by a policy evaluation engine (i.e., a processor) when a network request is delivered to the policy evaluation engine. In the current state of the art, a dynamically configured policy evaluation processor is implemented as an interpreter. A drawback to using an interpreter to evaluate a policy program is that the evaluation process is slow, since the text description of the program must be read and parsed for every policy evaluation.

### SUMMARY OF THE INVENTION

The present invention provides methods and systems for policy evaluation and load balancing of traffic in a network environment. The load balancer facilitates operation of a network by using an expression tree comprising data structures of precompiled executable code to determine an appropriate server group for sending traffic received from a client. When the switch receives a network request, such as an HTTP request, a policy evaluation processor executes the precompiled executable code to identify a group of network servers for servicing the request and forwards the request to the selected group of network servers. The request can then be load balanced among the selected server group through any suitable load-balancing algorithm.

According to a first aspect of the invention, a method of selecting a server for receiving a network request is provided. The method comprises the steps of pre-compiling executable code representing policies for specifying an action to be taken on a network request and executing the precompiled executable code to identify a server group for receiving the network request.

According to another aspect of the invention, a method of building an expression tree containing instructions for determining a group of servers for servicing a network request is provided. The method comprises the steps of receiving a user-defined policy program containing rules and policies for specifying actions to be taken on a network request, and translating the user-defined policy program into an expression tree comprising a plurality of internal data structures. Each data structure comprises a piece of precompiled executable code associated with a virtual service for identifying a service group for servicing a network request.

In still another aspect, a switch in a network communications system is provided. The switch comprises a parser for parsing an incoming network request into a plurality of values and a policy evaluation processor connected to the parser through a set of delineation structures. Each delineation structure defines a location, length and interpreted value of an HTTP object. The policy evaluation processor executes precompiled code representing user-specified policies specifying actions to be taken on a network request to identify a server for servicing the request.

### BRIEF DESCRIPTION OF THE DRAWINGS

The aforementioned features and advantages, and other features and aspects of the present invention, will become better understood with regard to the following description and accompanying drawings, wherein:

FIG. 1 is a block diagram of an illustrative network system employing a switch for load balancing.

FIG. 2 is a block diagram of the switch of FIG. 1 for load balancing.

FIG. 3 is a diagram of an expression tree for executing a policy evaluation process to identify a server for servicing a client request.

FIG. 4 is a flow chart of the steps involved in forming the expression tree of FIG. 3.

FIG. 5 is a flow chart of the steps involved in identifying a server for servicing a network request using the expression tree of FIG. 4.

### DETAILED DESCRIPTION

The illustrative embodiment of the present invention provides for evaluation of policies to provide load balancing of traffic destined in a network. While the invention will be described in conjunction with an illustrative embodiment, it will be understood that the invention is not limited to the illustrated embodiment. To the contrary, it is intended to cover alternatives, modifications, and equivalents as may be included within the spirit and scope of the invention as defined by the appended claims.

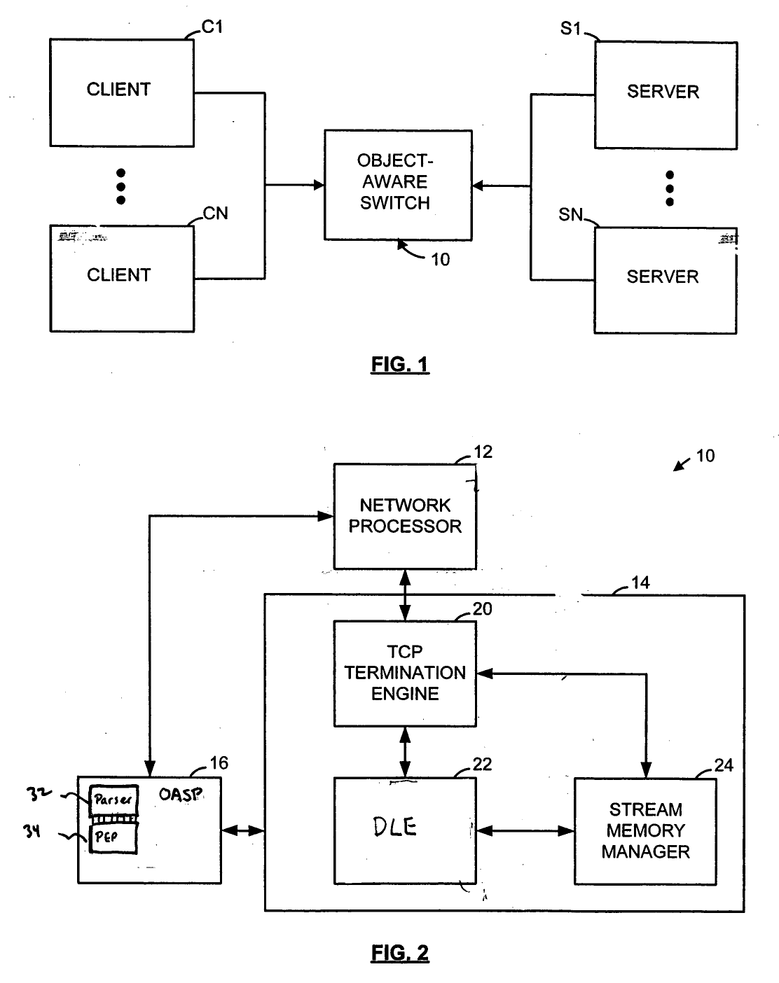

Referring to FIG. 1, an illustrative networked system according to the invention includes an application switch, illustrated as an object-aware switch (OAS) 10 to which one or more clients C1-CN are operatively connected. An object-aware switch is a switch i.e., a device that filters and forwards packets between segments of a network, that can process and delineate objects within a stream. A switch that is object aware understands where an object, such as an HTTP request or an HTTP response, starts and ends in a stream. An object can span one or more TCP (Transmission Control Protocol) segments. Alternatively, a single TCP segment can comprise multiple objects. The networked system also includes one or more servers S1-SN operatively connected to the OAS 10 via a transport-layer protocol, which can also be TCP. Generally, the OAS terminates transport-level connections with the clients C1-CN, performs object-aware policy operations on packets received through these connections, and relays information resulting from theses operations to new connections it establishes with one or more of the servers. The switch may be a stand-alone component or part of a server (e.g., a blade). In a typical installation, the clients may be remote Internet users, while the OAS and servers reside on a LAN that is isolated from the Internet by the OAS.

The switch 10 performs application switching, load balancing and high speed TCP termination and secure socket layer (SSL) acceleration for network data centers. The switch may implement virtual switching technology that allows enterprises or Internet Service Providers (ISPs) to create multiple virtual switches that are partitioned from one another within a single switch platform. Each virtual switch is a logical switch device having switching and routing capabilities, a traffic load balancer and SSL accelerator.

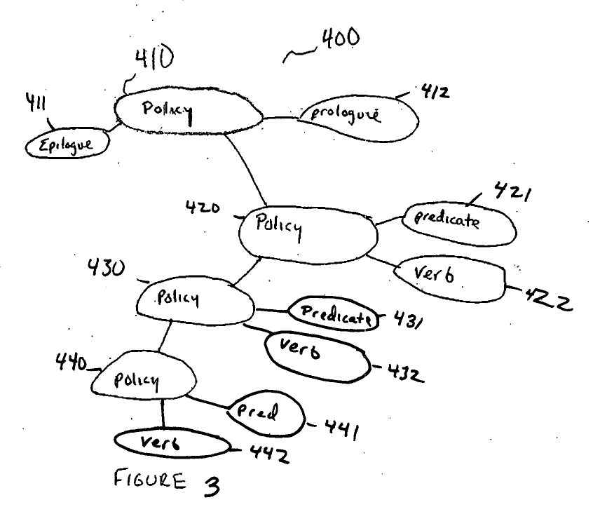

As shown in FIG. 2, the switch 10 includes a network processor (NP) 12 that is operatively connected between a switching fabric and a transport-layer engine 14, as well as to an object-aware switch processor (OASP) 16. The transport-layer engine 14 includes a transport-layer termination engine, such as a TCP termination engine (TTE) 20, which is operatively connected to a distillation and lookup engine (DLE) 22 and a stream memory manager (SMM) 24.

In an illustrative embodiment, the OASP 16 includes a parsing entity 32 for parsing an incoming request for connection and a policy evaluation processor 34, also known as a policy evaluation engine, connected to the parsing entity 32 through a set of delineation structures. The policy evaluation processor 34 executes pre-compiled executable code in a user-specified policy program to identify a server group, comprising a group of servers or services, for servicing the incoming network request. Alternatively, the parsing entity and/or the policy evaluation processor can be located on another entity of the switch 10.

The TTE 20 is responsible for responding to SYN packets and creating a session originating with one of the clients, C1-CN, though the OASP can also instruct the TTE to initiate a session to a particular host. A “SYN packet” is the first TCP/IP packet that is sent on a TCP connection, and is used to initiate the session. The TTE then receives the data stream for the session and sends the data stream to the SMM. When the stream has enough data in it, the TTE sends a message to the parsing entity that is responsible for the connection, which is a part of the OASP in the illustrative embodiment. The OASP 16 then parses and evaluates an underlying object from the data stream based on local policy rules. The OASP then identifies one of the destination servers S1-Sn for the object. The TTE creates a session with the identified destination server, and transfers the object to this server.

The OAS 10 can be designed according to a configurable design philosophy, which allows the various elements of the OAS to interoperate in a number of different ways with each other and with other elements. Configuration can be achieved by loading different firmware into various elements of the OAS and/or by loading configuration registers to define their behavior. Much of the configuration is performed for a particular application at startup, with some parameters being adjustable dynamically.

Using the configurable design approach, specialized functional modules can be implemented, such as a caching module, a security module, and a server load-balancing module. These modules can be the basis for a larger application switch that can perform object-aware switching, which involves performing switching on objects. A management port allows users to configure and monitor the switch via a command-line interface (CLI), a menu-based web interface, and/or Small Network Management Protocol (SNMP). A serial console port also allows users low level access to the CLI for remote maintenance and troubleshooting.

To perform load balancing using a load balancing module, the switch 10 inspects inbound network packets and makes forwarding decisions based on embedded content (terminated TCP) or the TCP packet header (non-terminated TCP) in the network packet. The switch executes policy evaluation code representing rules and policies (such as levels of service, HTTP headers, cookies, and so on) to identify a server group for servicing the request. After identifying a server group using the policy evaluation code, the switch applies a load balancing algorithm to identify a server within the group for servicing the request before forwarding the packets to the appropriate Web server designations. Examples of suitable load balancing algorithms for balancing a load within a selected server group include, but are not limited to, round robin, weighted round robin, weighted random selected and weighted hash selection.

During operation, the switch 10 can use virtualization to partition itself into multiple logical domains called virtual switches. The use of multiple virtual switches allows a data center to be partitioned among multiple customers based on the network services and applications the customers are running. Each virtual switch is an independent and uniquely-named logical system supporting switching and IP routing, load balancing, TCP traffic termination and SSL acceleration.

A load balancer application in each virtual switch defines the relationship between virtual services and real services. Each load balancer in a virtual switch is assigned to one or more virtual IP addresses (VIP), which is the address known to external networks. When the VIP receives a client request, the load balancer rewrites the IP address to that of a server or service identified for servicing the request using the policy evaluation process and load balancing algorithm of an illustrative embodiment of the invention, and Network Address Translation (NAT). When the selected Web server responds to the request, the switch rewrites the IP address to that of the VIP before forwarding the traffic back to the client.

According to an illustrative embodiment, the switch performs policy-based load balancing using precompiled code representing rules and individual policies defined by an operator for identifying a suitable server group for servicing a network request. A policy program stored in the switch 10 contains a precedence-based list of request policies, which are evaluated sequentially to determine forwarding behavior by specifying actions to be performed on an HTTP request. Each policy links a rule, which includes an operator-defined predicate statement that is to be compared against the request or a value in the request, to a selected service group. A rule with an action of “forward” for example, must have an associated designation server group for the forwarded traffic. When the request matches a predicate statement, the switch can make a decision to forward traffic to the server group associated with the rule, or take another action, such as redirect the request to another server, or reset the request if no rule matches exist. If the rule does not match, the policy evaluation processor moves to the subsequent rules in the program, which are evaluated in order of precedence until a match is found or there are no more rules to execute. Using the configured rules and policies, HTTP and HTTPS traffic is switched over inbound and outbound sessions.

Policy based matching operates on HTTP headers, cookies, URLs, or actual content over inbound and outbound sessions. For example, the switch can switch traffic between server groups using information passed in HTTP headers. In one example, a first policy can specify that all .gif image requests be forwarded to one service group, while a second policy can specify that all html requests be sent to another service group. One skilled in the art will recognize that any suitable standard or parameter for determining a suitable server group for servicing a particular request can be utilized.

According to an illustrative embodiment of the invention, the rules and policies for performing policy evaluations on incoming network requests are represented as an expression tree 400 consisting of internal data structures, as shown in FIG. 3. The data structures in the expression tree 400 are objects that contain precompiled executable code representing a specific piece of the policy execution process. The expression tree 400 represents each decision that can be made by a policy evaluation processor regarding where a request will be sent.

The policies 410, 420, 430, 440 and so on, are arranged as objects in order of precedence, with each policy comprising precompiled code containing a predicate (test) 411, 421, 431, 441, and verb (action) 412, 422, 432, 442 of a rule. In an illustrative embodiment, a single named policy is configured with each service group, though one skilled in the art will recognize that the invention is not limited to this embodiment. Each rule is a set of one or more operator-defined text expressions that compare object data and configuration data to determine a match and a resulting action. If an inbound HTTP request matches criteria specified in the rule, the switch executes the specified action, such as forward, retry or redirect, for the associated service group.

The user can set the order of precedence for the objects in the policy program using a selected command.

As the switch receives requests from the client, the policy evaluation processor attempts to match expressions in the rules against the HTTP request. The result of the comparison is either a match or a non-match. If the value from the incoming request matches the predicate statement, the switch executes the action specified in the policy on the request. Otherwise, the policy evaluation processor executes the precompiled code of the next policy, until either a match is found, or there are no more remaining policies in the expression tree. The user can configure a final default policy to specify a default action to take if all the rules are tried and no match is found. For example, the user can specify a default server group for servicing the request. Alternatively, a default policy instructs the switch to drop the request if no matching rule is found.

The syntax of a rule in an illustrative policy of the present invention uses the following format:
Rule<Rule_name>predicate {URI field_name:<operator>
[integer|string|keyword]}action [forward|redirect|reset]
   where <Rule_name> is any alphanumeric name with no blank spaces. The predicate is a Boolean function that returns either a true (match) or a false (non-match). Within a predicate statement, operators are used to determine how text strings and integers perform with a specified action. If the function is true, the specified action, forward, redirect or reset, is taken.

The policy evaluation processor 34 executes the precompiled code when a network request is received to identify a group of network servers suitable for servicing the request. Because the policy program defining the user-specified policy for selecting a server is represented by objects in the expression tree comprising precompiled code, performance is significantly increased. For example, by eliminating the need to read and parse a text description of the policy program using an interpreter, the runtime performance of a policy evaluation processor can be significantly improved.

In the illustrative embodiment of the invention, the top level object 410 in the expression tree represents the overall execution of the policy program. After generation of the expression tree 400, the top level passes back to the policy evaluation processor to configure a policy installation process. The policy installation process associates the expression tree 400 with a specific “policy offset”. The “policy offset” is a number which represents the virtual service internal to the switch. When a connection is made to the specific virtual service IP address/port and a request is received, the data for that request is sent along with the number for the virtual service. The policy evaluation processor 34 in the OAS 10 uses the number defined by the policy offset to locate the policy program to execute.

As shown, the top level object 410 is a policy that includes an epilogue 411 and a prologue 412. In the illustrative embodiment, the prologue 412 is a piece of precompiled code that specifies how to control TCP sessions. The “prologue” code contained in the prologue 412 gathers information from the request that will be used by the connection management software to control the TCP session on which the request was received. This information is passed to the connection management software as a data structure, which is formatted by the precompiled “epilogue” code in the epilogue 411. The information that is formatted by the epilogue code also contains the number/identifier that specifies which group of back-end servers to use to service the request.

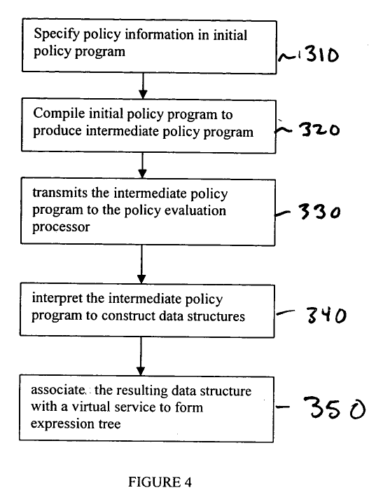

In an illustrative embodiment, the policy program configured by the user is generated by extensions to a TCL interpreter to construct the expression tree 400 containing discrete objects, each representing a specific piece of a policy execution process and containing the data required to execute the policy execution process. FIG. 4 illustrates the steps involved in building the expression tree 400 for executing a policy execution process to specify a group of servers for servicing a network request. The expression tree 400 is translated from an initial user-specified policy program containing user-specified policies represented as programming language expressions. One skilled in the art will recognize that the invention is not limited to the illustrative method for building the expression tree, and that any suitable format and method may be used to create an expression tree for evaluating policies.

In a first step 310, a user specifies policy information, such as rules, predicates, policies, information regarding service groups and precedence, as described above, by entering the policy information in an initial policy program via a command-line interface. In the initial policy program, the policy information is represented as programming language expressions.

After receiving the user-specified policy information, a compilation processor produces an intermediate policy program by compiling the programming language expressions representing the user-specified policy information into an internal intermediate format in step 320. According to the illustrative embodiment, the type code in the intermediate policy program is TCL script, though one skilled in the art will recognize that any suitable language may be used. In step 330, the compilation processor transmits the intermediate policy program containing the policy information to the policy evaluation processor of the switch. The policy evaluation processor, in step 340, interprets the intermediate policy program to construct the data structures, i.e., the discrete objects in the expression tree 400.

According to an illustrative embodiment of the invention, during the policy program installation phase, step 340, where the intermediate format is translated into an expression tree, the policy evaluation processor performs optimizations to the expression tree that are not specified in the intermediate format. For example, the evaluation processor can recognize a string match consisting of only a wildcard and translate the test to a simple test for presence only.

Finally, in step 350, the policy evaluation processor associates the resulting data structure produced in step 340 with a virtual service, which identifies a server group, or server group for which the program is to execute. Step 350 results in the formation of the expression tree 400 for performing policy evaluations on incoming network requests.

The configuration of a policy program for load balancing in step 310 generally involves adding web hosts to the virtual switches, then defining real services that are running on the server. A real service, associated with a server, is identified by a real service name. The real service defines the expected type of inbound and outbound traffic processed by the host, defined by the IP address and application port. Real services have assigned weights when they participate in load balancing groups. After adding web hosts and defining real services, the operator then creates the service groups for fulfilling Web service requests. A server group assigns a particular load-balancing algorithm to the services in the group, along with other configurable characteristics. Examples of different load balancing algorithms within a service group that can be supported include, but are not limited to: weighted hash, weighted random, round robin, source address, least connections and others known in the art.

In step 310, after creating the server groups, the operator configures the rules for matching and forwarding traffic to the server groups. To configure the rules, the user defines one or more predicate expressions that compare an HTTP request with a set of rules. After configuring the rules for matching and forwarding HTTP requests, the operator assigns the policies to link the rules to server groups, so when a match to the selected rule is found, the matched request is sent to the associated server group. The user then configures virtual services that link a VIP to a policy. The virtual service links a policy to the externally visible virtual IP address (VIP). When the VIP receives a client HTTP request, the virtual service uses the policy to identify the server group containing candidate servers for fulfilling request. This can include an evaluation of the traffic against rules and the configured policy.

For example, in step 310, the user can specify characteristics of the policy program using a CLI. For example, the user can specify the name of a request policy using the field name <NamedIndex>. The user can specify an action to be taken on a policy rule match using the field action. The field Rule <NamedIndex> specifies a rule defining a predicate used to evaluate a response. If the object, i.e., the HTTP request, matches the predicate, the fields in the Rule table will be applied to the object. The field precedence (1 . . . ) specifies the precedence of the associated policy, with a precedence of 1 being the highest. The field serviceGroupName <NamedIndex> is used to specify a service group associated with the particular policy. One skilled in the art will recognize that any suitable format, syntax and means for configuring the policy can be implemented by the user.

U.S. patent application Ser. No. 10/414,606, the contents of which are herein incorporated by reference, describes a sample configuration session for creating rules that allows inbound HTTP requests to a selected server group to be load balanced and forwarded to the appropriate servers. U.S. patent application Ser. No. 10/414,606 also describes HTTP request and HTTP response headers and field names that can be supplied with a rule, along with one or more rule command examples, URI field names supported by the application switch 10, operators associated with rule predicate statements, keywords associated with specific rule predicate statements, options in an rule for refining how traffic is forwarded and other details for configuring rules according to an illustrative embodiment.

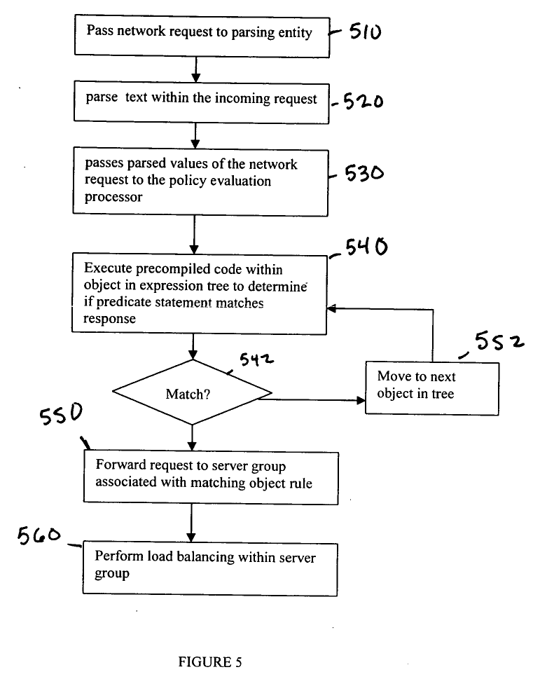

FIG. 5 illustrates the steps involved in determining a suitable group of network servers for servicing an incoming network request using the expression tree 400 according to an illustrative embodiment of the invention. In step 510, a network request is passed to the parsing entity in the OASP of the switch 10. In step 520, the parsing entity executes a parsing program to parse the text within the incoming request, for example, text within the header, to extract, delineate and validate values of interest. In the illustrative embodiment of the invention, the parsing program, which contains instructions for parsing the incoming network request into a plurality of data pieces, is a statically compiled C implementation of a predefined parse configuration that is separate from the expression tree of the policy program. The parsing program of the illustrative embodiment uses a general parsing tree that is used to identify the key portions of data in an incoming stream.

After parsing, the parsing entity passes the parsed values of the network request to the policy evaluation processor in step 530. In the illustrative embodiment, the connection between the parse program and the policy program 400 is through a set of delineation structures. Each delineation structure defines the location, length and interpreted value of a piece of data, such as a piece of an HTTP object, provided by the parser. The delineations are tied to the user-defined configurations as pseudo-variables that can be used on policy expressions.

In step 540, the policy evaluation processor executes the precompiled code within the expression tree 400 using the parsed values of the network request to determine which group of network servers is to service the network request. If the policy evaluation processor matches an HTTP request, or at value in an HTTP request, with an expression in a rule being evaluated, an action associated with the rule is taken. When a match is found (step 542), the policy evaluation processor instructs connection management software to forward the request to the server group associated with the particular data structure containing the precompiled code producing the match, which then forwards the request in step 550. Otherwise, the switch moves to the next object in the expression tree (step 552) and returns to step 540 to execute the precompiled code in the next object of the expression tree. The switch continues to attempt to match the HTTP request with the next rule in order of precedence until a match is found or until the switch evaluates all rules. The policy evaluation processor can take another action, such as redirect the request to another server, or reset the request if no rule matches exist. If the switch cannot determine a match, or if there are no remaining rules, the switch drops the request and sends a warning stating that no policy matches were found. Alternatively, as described above, the user can configure a default policy rule to specify a default action of forwarding the request to a default server group.

In step 560, the server group that receives the request can then perform load balancing among the servers in the group to identify a server for servicing the request. The load balancing within a server group can be executed using any suitable load balancing algorithm.

As described above, in the illustrative embodiment of the invention, a policy program containing the rules and policies is translated into an expression tree of internal data structures to facilitate execution of the policy evaluation process. In contrast, prior systems represent user-specified policies as programming language expressions that must be evaluated at runtime using an interpreter.

In the present invention, the use of an expression tree containing discrete object of precompiled code for evaluating policies provides significant advantages over prior methods of using an interpreted policy program to select a group of servers. The use of precompiled code eliminates the need to read and parse the text description of the policy program, which takes considerable time and delays the process of selecting a server and sending the request to a server. Because the policy program contains precompiled code that is determined prior to runtime, the policy program does not need to be run through an interpreter during runtime, which streamlines the evaluation process.

It will thus be seen that the invention attains the objectives stated in the previous description. Since geometric changes may be made without departing from the scope of the present invention, it is intended that all matter contained in the above description or shown in the accompanying drawings be interpreted as illustrative and not in a literal sense. For example, the illustrative embodiment of the present invention may be practiced with any servers that process bidirectional traffic in networks. Practitioners of the art will realize that the sequence of steps and architectures depicted in the figures may be altered without departing from the scope of the present invention and that the illustrations contained herein are singular examples of a multitude of possible depictions of the present invention.

What is claimed is:

1. A method of selecting a server for receiving a network request comprising the steps of:
pre-compiling executable code representing policies for specifying an action to be taken on a network request; and
executing the precompiled executable code to identify a server group for receiving the network request.

2. The method of claim 1, wherein the step of executing comprises comparing a value of the network request to a first rule represented by the precompiled executable code, wherein the first rule is associated with a first server group.

3. The method of claim 2, further comprising the instructing a connection manager to forward the network request to the first server group if the value matches a predicate statement in the rule.

4. The method of claim 2, further comprising the step of passing the value of the network request to a second rule represented by precompiled executable code and associated with a second server group if the value does not match a predicate statement in the second rule.

5. The method of claim 4, further comprising the step executing the precompiled executable code representing the second rule using the value as an input.

6. The method of claim 5, further comprising the step of instructing a connection manager to forward the network request to the second server group if the value matches a predicate statement in the second object.

7. The method of claim 1, further comprising the step of receiving the network request prior to the step of executing the executing the precompiled executable code.

8. The method of claim 7, further comprising the step of parsing the received network request into a plurality of values prior to the step of executing the precompiled executable code.

9. The method of claim 3, further comprising the step of executing a load balancing algorithm to identify a server within the first server group for servicing the request.

10. The method of claim 9, wherein the load balancing algorithm is one of: round robin, weighted round robin, weighted random selected and weighted hash selection.

11. The method of claim 1, wherein the precompiled code contains a predicate statement and an action to be taken if the network request value matches the predicate statement.

12. A method of building an expression tree containing instructions for determining a group of servers for servicing a network request, comprising the steps of:
receiving a user-defined policy program containing rules and policies for specifying actions to be taken on a network request; and
translating the user-defined policy program into an expression tree comprising a plurality of internal data structures, each data structure comprising a piece of precompiled executable code associated with a virtual service for identifying a service group for servicing a network request.

13. The method of claim 12, wherein the step of translating comprises the steps of:
compiling the user defined-policy program into an intermediate format;
interpreting the intermediate format using a policy evaluation processor to form data structures; and
associating the data structures with a virtual service.

14. The method of claim 13, wherein the virtual service identifies a first service group for servicing a network request.

15. The method of claim 13, further comprising the step of performing local optimizations during the step of interpreting the intermediate format.

16. The method of claim 12, further comprising the step of creating the user-defined policy program by entering programming language expressions defining said rules and policies in a command line interface.

17. In a network communications system, a switch comprising:
a parser for parsing an incoming network request into a plurality of values; and
a policy evaluation processor connected to the parser through a set of delineation structures, where each delineation structure defines a location, length and interpreted value of an HTTP object, wherein the policy evaluation processor executes precompiled code representing user-specified policies specifying actions to be taken on a network request to identify a server for servicing the request.

18. The switch of claim 17, further comprising a compiler for compiling a user defined-policy program into an intermediate format.

19. The switch of claim 18, wherein the policy evaluation processor interprets the intermediate format to form data structures containing the precompiled code.

20. The switch of claim 17, wherein the policy evaluation processor associates the data structures with a virtual service that identifies a server group.
